(19) United States
(12) Patent Application Publication
(10) Pub. No.: US 2011/0067007 A1
(43) Pub. Date: Mar. 17, 2011

(54) AUTOMATIC THREAD DUMPING

(75) Inventor: Galder Zamarreño, Neuchatel (CH)

(73) Assignee: Red Hat, Inc., Raleigh, NC (US)

(21) Appl. No.: 12/558,677

(22) Filed: Sep. 14, 2009

(51) Int. Cl. G06F 9/44

(52) U.S. Cl. 717/128

(57) ABSTRACT

A server node comprises a monitoring module to support automatic thread dumping. The monitoring module monitors execution of a multi-threaded Java program on a Java virtual machine. The monitoring module detects a pre-defined condition that occurs to one or more of the threads during the execution. Upon detection of the pre-defined condition, the monitoring module automatically invokes a thread dumping module to dump the threads that are currently running on the Java virtual machine.

### TECHNICAL FIELD

Embodiments of the present invention relate to computer programming and, more specifically, to a Java-based application server that supports automatic thread dumping.

### BACKGROUND

An application server is a software framework that delivers applications to client computers or devices. An application server facilitates software development by allowing designers and programmers to devote their time to meeting software requirements rather than dealing with the standard low-level details of providing a working system. An application server can be provided as middleware that sits between operating systems and high-level enterprise applications. An application server enables applications to intercommunicate with dependent applications, such as transaction servers, database management systems, and web servers.

A Java-based application server can support multi-threaded programming. An application executed by a Java virtual machine can contain multiple threads that run concurrently to perform different tasks. Sometimes, a thread may encounter an exception, such as a timeout exception, indicating that a resource is unreachable. An application developer can send a command to dump the context of the threads that run on the Java virtual machine to determine the cause of the exception. However, in some scenarios, the timing of thread dumping may be important. The conventional command-driven manual thread dumping requires the intervention of a user (e.g., a system administrator) and sometimes may not produce the desired results for the purposes of debugging and performance evaluation.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 is a block diagram of an exemplary architecture in which embodiments of the invention may be implemented.

FIG. 2 is a block diagram illustrating one embodiment of a monitoring module that runs on one or more server nodes in a server cluster.

FIG. 3 is a flow diagram illustrating a method of automatic thread dumping, in accordance with one embodiment of the present invention.

FIG. 4 illustrates a diagrammatic representation of a machine in the exemplary form of a computer system, in accordance with one embodiment of the present invention.

### DETAILED DESCRIPTION

Described herein is a method and system that supports automatic thread dumping on a Java platform. In one embodiment, a server node comprises a monitoring module to support automatic thread dumping. The monitoring module monitors execution of a multi-threaded Java program on a Java virtual machine. The monitoring module detects a pre-defined condition that occurs to one or more of the threads during the execution. Upon detection of the pre-defined condition, the monitoring module automatically invokes a thread dumping module to dump the threads that are currently running on the Java virtual machine without the intervention of a user.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “monitoring”, “detecting”, “dumping”, “determining”, “checking”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

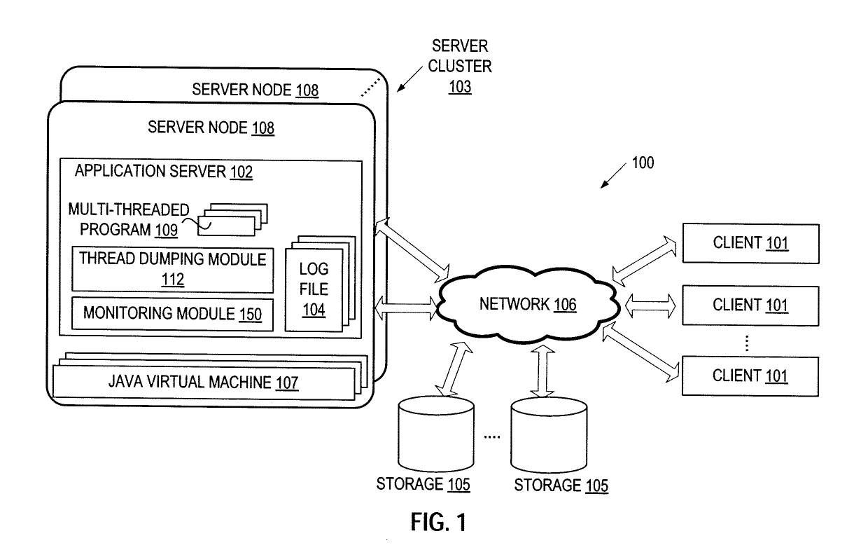

FIG. 1 illustrates an exemplary network architecture 100 in which embodiments of the present invention may operate. The network architecture 100 may include client devices (clients) 101, a network 106 and one or more server nodes 108 in a server cluster 103. The clients 101 may be general-purpose, special-purpose or multi-function computing/communication devices, for example, server machines, workstations, personal computers (PCs), portable computing devices, mobile phones, personal digital assistants (PDAs), etc. The network 106 may be a private network (e.g., a local area network (LAN), wide area network (WAN), intranet, etc.) or a public network (e.g., the Internet).

In one embodiment, each server node 108 in the server cluster 103 is a computer that provides Java-based services to the clients 101. Examples of the services include transaction services, Web services, messaging services, or other enterprise services. The services can be accessed by the clients 101 via the network 106.

The server node 108 may be coupled to data storage 105 locally or remotely via the network 106. The data storage 105 may be centrally located, or distributed over multiple geographic locations. The data storage 105 may include memory, caches, data drives, internal or external storages, mass storage, etc., and may store one or more data repositories or databases. It is understood that the network architecture 100 may include any numbers of the servers 108, networks 106, clients 101 and data storage 105.

In one embodiment, the server node 108 runs an application server 102 that serves as middleware for enterprise applications. The application server 102 includes a microcontainer (not shown) to support the services accessible by the clients 101. The term “container” refers to a software construct (e.g., class) that holds or organizes software objects (e.g., Java objects). A container also includes methods for adding and removing objects, as well as methods for iterating the addition and removal of the objects. The application server 102 deploys software components into the microcontainer for execution on one or more Java virtual machines 107. In one embodiment, the application server 102 deploys a number of multi-threaded Java programs 109 into the microcontainer, with each Java program 109 executed by one Java virtual machine 107. The Java programs 109 and the threads spawned from each Java program 109 can be executed concurrently. Threads running on different server nodes 108 may cooperate to complete a given task.

The application server 102 may include a monitoring module 150, which monitors the execution of the threads on each Java virtual machine 107. The monitoring module 150 can detect the occurrence of a pre-defined condition, such as a timeout exception, a remote procedural call (RPC) sync call timeout, a deadlock, a request pending for more than a pre-determined amount of time (e.g., 10 ms), or other conditions which an application programmer may want to investigate for performance or debugging purposes. In one embodiment, the monitoring module 150 monitors the data that is printed to a log file 104, which is generated during the runtime of an associated multi-threaded program 109, to determine whether a pre-defined condition has occurred. Once the occurrence of the pre-defined condition is detected, the monitoring module 150 invokes a thread dumping module 112 to dump the threads associated with the multi-threaded program 109. For example, the monitoring module 150 may wait for a call from the program 109 to log a warning message. If the warning message contains a pre-determined pattern, the monitoring module 150 will invoke the thread dumping module 112 to dump the threads associated with the program 109. The output of thread dumping includes the context of the threads, which is sent to a thread dumping log file that logs the dumped context.

In one embodiment, the dumped threads include all of the threads that are currently running on the Java virtual machine 107, in which the pre-defined condition is detected. In a scenario where the identifiers of the threads are known, the thread dumping module 112 may selectively dump some of the threads on the Java virtual machine 107 that are most relevant to the pre-defined condition. For example, if a thread attempts to acquire a lock to a data record and causes a deadlock, the other threads that are currently holding the lock can be automatically dumped. Selective thread dumping allows an application user or developer to gain insight to the inner working of the threads that are most likely the cause of an abnormal condition. In yet another scenario, if a thread causing a timeout (or other pre-defined condition) is related to some of the threads on another server node 108 in the server cluster 103, the monitoring module 150 can send a request to the other server node 108 to dump all of those related threads.

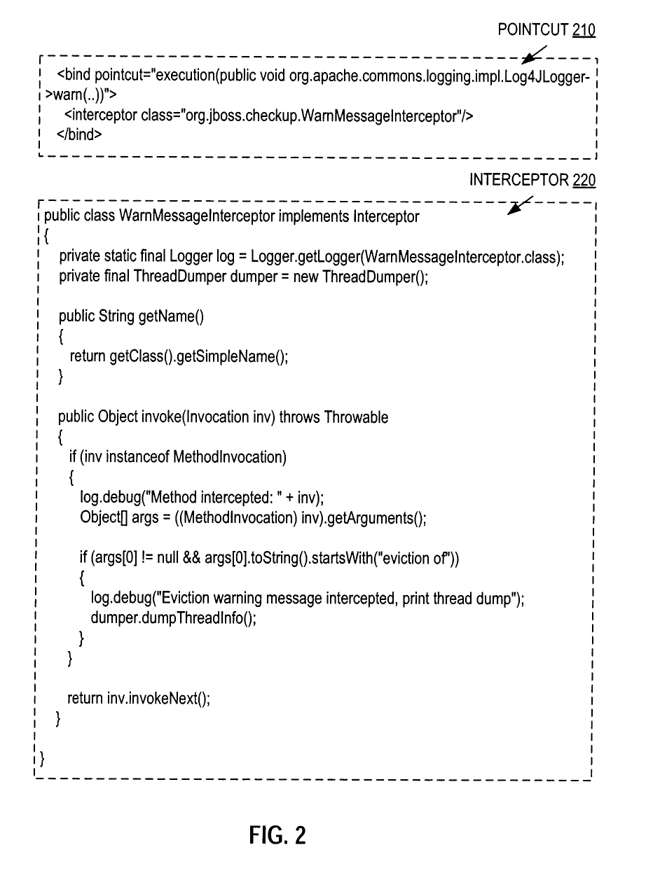

FIG. 2 is an example of Java code that can be incorporated into an embodiment of the monitoring module 150. In this embodiment, the monitoring module 150 is implemented with Aspect-oriented programming (AOP). AOP is a programming approach that was developed to address the limited manageability of crosscutting concerns in conventional programming approaches. An aspect includes a concern that crosscuts the primary modularization of a program. An AOP language encapsulates crosscutting concerns in a number of special purpose program modules called aspects, rather than spreading the implementation of such concerns throughout the modules that include core concerns of a program. An aspect is the unit of modularity for crosscutting concerns, and includes a pointcut and advice. A pointcut is program code that picks out certain join points (a clearly definable point in a program flow, examples of which include method calls, exception throws, etc.) and values at those points. Advice is code (e.g., one or more operations) that can be executed when a join point is reached.

In the embodiment shown in FIG. 2, the monitoring module 150 includes a pointcut 210 that defines a triggering condition (i.e., a join point) for automatic thread dumping. The pointcut 210 detects when a WARN message is printed into a log file (e.g., the log file 104). Upon detection of the WARN message, the pointcut 210 causes the code in org.jboss.checkup.WarnMessageInterceptor (i.e., an interceptor 220) to be executed. The interceptor 220 contains advice code associated with the pointcut 210. The interceptor 220 waits for a WARN message which starts with “eviction of.” Once such WARN message is detected, the interceptor 220 requests some other code (e.g., the thread dumping module 112) to dump all the threads that run on the Java virtual machine 107 without the intervention of a user.

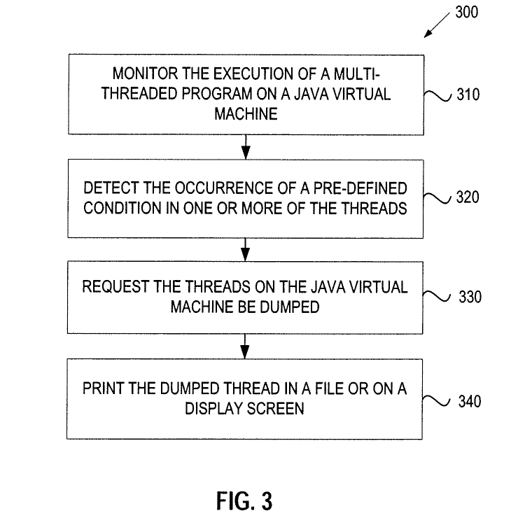

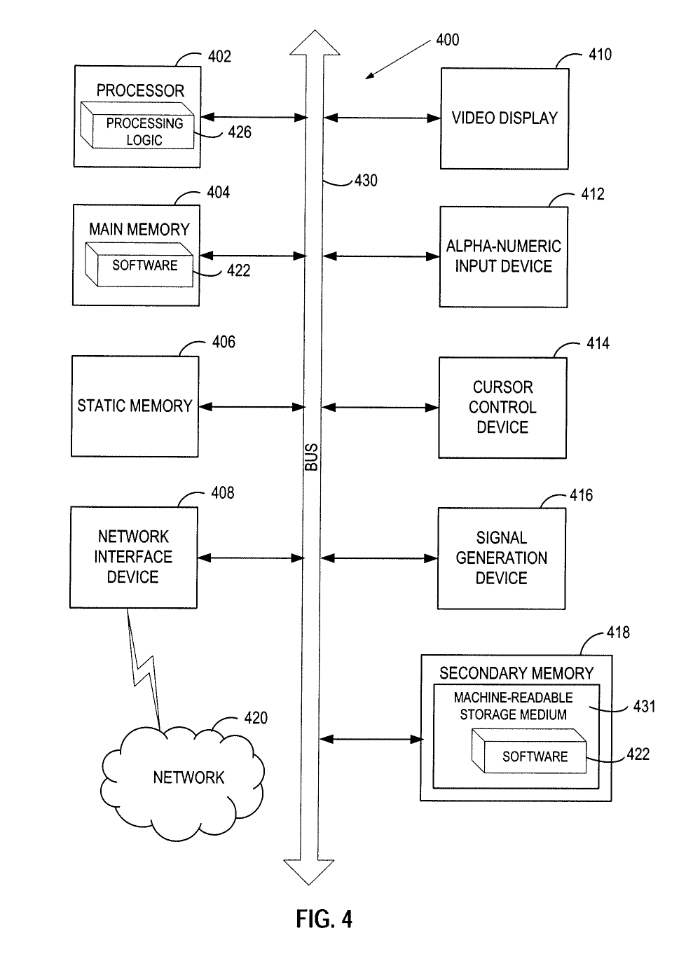

FIG. 3 is a flow diagram illustrating an example of a method 300 for automatically dumping threads when a pre-defined condition occurs. The method 300 may be performed by processing logic 426 of FIG. 4 that may comprise hardware (e.g., circuitry, dedicated logic, programmable logic, microcode, etc.), software (e.g., instructions run on a processing device to perform hardware simulation), or a combination thereof. In one embodiment, the method 300 is performed by the monitoring module 150 on the server node 108 of FIG. 1.

Referring to the embodiment of FIG. 3, the method 300 begins when the monitoring module 150 monitors the execution of the multi-threaded program 109 on the Java virtual machine 107 (block 310). The monitoring module 150 may monitor data that is printed to the log file 104 associated with the multi-threaded program 109. The monitoring module 150 may include multiple pointcuts (e.g., the pointcut 210), each pointcut for detecting a specific pre-defined condition. When one of the pre-defined conditions is detected (block 320), the monitoring module 150 automatically invokes the thread dumping module 112 to dump the threads in the multi-threaded program 109 that are currently running on the Java virtual machine 107 (block 330). The result of thread dumping can be printed into a file or on a display screen for a user or a developer to debug or to evaluate the performance of the program 109 (block 340). The monitoring module 150 may continue monitoring the execution of the multi-threaded program 109 until the program ends.

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a secondary memory 418 (e.g., a data storage device), which communicate with each other via a bus 430.

The processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The secondary memory 418 may include a machine-readable storage medium (or more specifically a computer-readable storage medium) 431 on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting machine-readable storage media. The software 422 may further be transmitted or received over a network 420 via the network interface device 408.

The machine-readable storage medium 431 may store the monitoring module 150 and/or the thread dumping module 112 (FIG. 1). While the machine-readable storage medium 431 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method comprising:
monitoring, at a monitoring module of a server, execution of a Java program on a Java virtual machine, the Java program including a plurality of threads;
detecting, at the monitoring module, a pre-defined condition that occurs to one or more of the threads during the execution; and
automatically dumping the threads that are currently running on the Java virtual machine in response to detection of the pre-defined condition.

2. The method of claim 1, wherein detecting occurrence of a pre-defined condition further comprises:
monitoring data printed to a log file to detect the occurrence of the pre-defined condition, the log file generated during the execution of the Java program.

3. The method of claim 1, wherein the detecting and automatically dumping are implemented with Aspect-Oriented Programming.

4. The method of claim 1, wherein detecting occurrence of a pre-defined condition further comprises:
monitoring data printed to a log file, the log file generated during the execution of the Java program;
determining whether the data includes a warning message that contains a pre-determined pattern; and
invoking a thread dumping module to dump the threads in response to a determination that the data includes the warning message that contains the pre-determined pattern.

5. The method of claim 1, further comprising:
determining identifiers of the threads; and
selectively dumping the threads using the identifiers.

6. The method of claim 1, further comprising:
requesting a remote server to dump all threads that are related to the threads that are currently running on the server.

7. The method of claim 1, wherein the pre-defined condition comprises one of the following: a timeout exception, a remote procedural call (RPC) sync call timeout, a deadlock, or a request pending for more than a pre-determined amount of time.

8. A system comprising:
memory to store context of a plurality of threads of a multi-threaded Java program; and
a server node coupled to the memory to monitor execution of the Java program on a Java virtual machine, to detect a pre-defined condition that occurs to one or more of the threads during the execution, and to automatically dump the threads on the Java virtual machine in response to detection of the pre-defined condition.

9. The system of claim 8, wherein a server node is to generate a log file during the execution of the Java program, and to monitor data printed to the log file to detect the occurrence of the pre-defined condition.

10. The system of claim 8, wherein the server node further comprises:
a monitoring module implemented with Aspect-Oriented Programming to monitor the execution of the Java program.

11. The system of claim 8, wherein the server node is to generate a log file during the execution of the Java program, to determine whether data printed to the log file includes a warning message that contains a pre-determined pattern, and to invoke a thread dumping module to dump the threads in response to a determination that the data includes the warning message that contains the pre-determined pattern.

12. The system of claim 8, wherein the server node is to determine identifiers of the threads, and to selectively dump the threads with use of the identifiers.

13. The system of claim 8, wherein the server node is to request a remote server to dump all threads that are related to the threads that are currently running on the server.

14. The system of claim 8, wherein the pre-defined condition comprises one of the following: a timeout exception, a remote procedural call (RPC) sync call timeout, a deadlock, or a request pending for more than a pre-determined amount of time.

15. A computer readable storage medium including instructions that, when executed by a processing system, cause the processing system to perform a method comprising:
monitoring execution of a Java program on a Java virtual machine, the Java program including a plurality of threads;
detecting a pre-defined condition that occurs to one or more of the threads during the execution; and
automatically dumping the threads that are currently running on the Java virtual machine in response to detection of the pre-defined condition.

16. The computer readable storage medium of claim 15, wherein detecting an occurrence of a pre-defined condition further comprises:
monitoring data printed to a log file to detect the occurrence of the pre-defined condition, the log file generated during the execution of the Java program.

17. The computer readable storage medium of claim 15, wherein the detecting and automatically dumping are implemented with Aspect-Oriented Programming.

18. The computer readable storage medium of claim 15, wherein detecting an occurrence of a pre-defined condition further comprises:
monitoring data printed to a log file to detect the occurrence of the pre-defined condition, the log file generated during the execution of the Java program;
determining whether the data includes a warning message that contains a pre-determined pattern; and
invoking a thread dumping module to dump the threads in response to a determination that the data includes the warning message that contains the pre-determined pattern.

19. The computer readable storage medium of claim 15, wherein the method further comprises:
determining identifiers of the threads; and
selectively dumping the threads using the identifiers.

20. The computer readable storage medium of claim 15, wherein the method further comprises:
requesting a remote server to dump all threads that are related to the threads that are currently running on the server.
